(19) United States
(12) Patent Application Publication
(10) Pub. No.: US 2023/0420988 A1
(43) Pub. Date: Dec. 28, 2023

(54) WIRELESS POWER SYSTEM

(71) Applicant: Apple Inc., Cupertino, CA (US)

(72) Inventors: Zaki Moussaoui, San Carlos, CA (US); Jukka-pekka J. Sjoeroos, Cupertino, CA (US); Weihong Qiu, San Ramon, CA (US); Zelin Xu, San Jose, CA (US)

(21) Appl. No.: 18/463,486

(22) Filed: Sep. 8, 2023

Related U.S. Application Data
(63) Continuation of application No. 17/127,733, filed on Dec. 18, 2020.
(60) Provisional application No. 62/981,698, filed on Feb. 26, 2020.

(51) Int. Cl. H02J 50/00; H02J 50/12; H02J 50/90

(52) U.S. Cl. CPC H02J 50/005; H02J 50/12; H02J 50/90

(57) ABSTRACT

A wireless power system has a wireless power transmitting device and multiple wireless power receiving devices. The wireless power transmitting device may have a foldable housing. The wireless power transmitting device has wireless power coils that are used in transmitting wireless power to electronic devices such as cellular telephones, wristwatches, ear buds battery cases, ear buds, computer styluses, and other electronic devices. A rectifier can be coupled to a wireless power coil. In a first mode the coil transmits wireless power to a cellular telephone or other device. In a second mode, the coil is used in receiving wireless power from the cellular telephone or other device. The received wireless power can be retransmitted to other devices.

### CROSS-REFERENCE TO RELATED APPLICATIONS

This is a continuation application of U.S. patent application Ser. No. 17/127,733, filed Dec. 18, 2020, entitled “WIRELESS POWER SYSTEM”; which claims priority to and the benefit of U.S. Provisional Application No. 62/981,698, filed Feb. 26, 2020, entitled “WIRELESS POWER SYSTEM,” both disclosures of which are incorporated by reference in its entirety.

### BACKGROUND

This relates generally to power systems, and, more particularly, to wireless power systems for charging electronic devices.

In a wireless charging system, a wireless power transmitting device such as a charging mat wirelessly transmits power to a wireless power receiving device such as a portable electronic device. The portable electronic device has a coil and rectifier circuitry. The coil of the portable electronic device receives alternating-current wireless power signals from the wireless power transmitting device. The rectifier circuitry converts the received signals into direct-current power.

### SUMMARY

A wireless power system has a wireless power transmitting device and multiple wireless power receiving devices. The wireless power transmitting device has a housing and multiple wireless power coils configured to operate respectively with the multiple wireless power receiving devices.

The wireless power transmitting device has a housing such as a foldable housing. A wired power port in the power transmitting device is configured to couple to a cable providing wired power. An optional wireless power receiving coil and optional battery can be used to receive wireless power and store power.

The wireless power coils are used in transmitting wireless power to electronic devices such as cellular telephones, wristwatches, ear buds battery cases, ear buds, computer styluses, and other electronic devices. A rectifier can be coupled to a wireless power coil. In a first mode the coil transmits wireless power to a cellular telephone or other device. In a second mode, the coil is used in receiving wireless power from the cellular telephone or other device. In this way, power can be harvested from a battery of the cellular telephone or other device and redistribute to a wristwatch, computer stylus, ear buds battery case, ear buds, or other electronic devices.

### BRIEF DESCRIPTION OF THE DRAWINGS

FIG. 1 is a schematic diagram of an illustrative wireless power system in accordance with an embodiment.

FIG. 2 is a circuit diagram of illustrative wireless power system circuitry in accordance with an embodiment.

FIG. 3 is a diagram of an illustrative ear bud and associated wireless power transmitting circuit in a portion of a wireless power transmitting device in accordance with an embodiment.

FIG. 4 is a circuit diagram of an illustrative wireless power system in accordance with an embodiment.

FIG. 5 is a top view of an illustrative device in accordance with an embodiment.

FIGS. 6, 7, 8, and 9 are top views of portions of an illustrative device and associated equipment in accordance with an embodiment.

FIG. 10 is a side view of an illustrative device in accordance with an embodiment.

### DETAILED DESCRIPTION OF SPECIFIC EMBODIMENTS

A wireless power system includes a wireless power transmitting device. The wireless power transmitting device wirelessly transmits power to one or more wireless power receiving devices. Power for the wireless power transmissions is received from external equipment or is harvested from one of the wireless power receiving devices. If desired, power for the wireless power transmissions may be stored in an optional internal battery.

The wireless power receiving devices are devices such as wrist watches, cellular telephones, tablet computers, laptop computers, wireless ear buds (in-ear headphones), battery cases for earbuds or other equipment, computer styluses, or other electronic equipment. The wireless power receiving devices use power from the wireless power transmitting device for charging internal batteries and powering internal circuitry.

The wireless power transmitting device has a housing. Coils for transmitting and/or receiving wireless power and other wireless power circuitry are housed within the housing. Magnets may also be housed within the housing. During charging operations, the magnets may be used to hold the wireless power receiving devices in place in alignment with the coils.

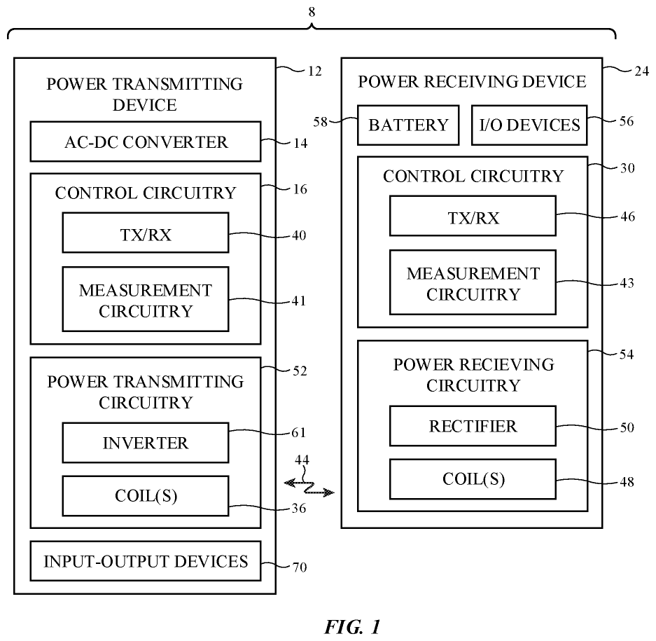

An illustrative wireless power system (wireless charging system) is shown in FIG. 1. As shown in FIG. 1, wireless power system 8 includes a wireless power transmitting device such as wireless power transmitting device 12 and includes multiple wireless power receiving devices such as illustrative wireless power receiving device 24. Wireless power transmitting device 12 includes control circuitry 16. Each wireless power receiving device 24 includes control circuitry 30. Control circuitry in system 8 such as control circuitry 16 and control circuitry 30 is used in controlling the operation of system 8. This control circuitry may include processing circuitry associated with microprocessors, power management units, baseband processors, digital signal processors, microcontrollers, and/or application-specific integrated circuits with processing circuits. The processing circuitry implements desired control and communications features in devices 12 and 24. For example, the processing circuitry may be used in selecting coils, determining power transmission levels, processing sensor data and other data to detect foreign objects and perform other tasks, processing user input, handling negotiations between devices 12 and 24, sending and receiving in-band and out-of-band data, making measurements, and otherwise controlling the operation of system 8.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in the control circuitry. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU) or other processing circuitry.

Power transmitting device 12 may operate as a stand-alone power adapter (e.g., a wireless charging mat that includes power adapter circuitry), may be coupled to a power adapter or other equipment by a cable, may be a portable device such as a foldable device, may include a battery, may serve as a cover or case, or may be other wireless power transfer equipment. Illustrative configurations in which wireless power transmitting device 12 transmits wireless power to multiple wireless power receiving devices 24 are sometimes described herein as an example.

Each of the power receiving devices in system 8 such as device 24 of FIG. 1 may be a portable electronic device such as a wrist watch, a cellular telephone, a laptop computer, a tablet computer, an accessory such as a computer stylus, an earbud, a battery case for ear buds, a battery case for other electronic devices, or other electronic equipment. Power transmitting device 12 may have source of power such as a battery and/or may receive power wirelessly from one of devices 24 (e.g., device 12 may harvest battery power from a portable device such as one of devices 24 that might otherwise wirelessly receive power from device 12). Device 12 may also receive power wirelessly from a charging mat or other external wireless power transmitting device, and/or may receive power from a wired connection. Device 12 may, for example, have a wired power port that receives direct-current (DC) power from an external power adapter or that receives alternating-current (AC) power from a wall outlet or other AC power source. When power is supplied to device 12 from an AC source, device 12 uses AC-DC power converter 14 for converting AC power into DC power.

Direct-current power in device 12 is used to power control circuitry 16. During operation, a controller in control circuitry 16 uses power transmitting circuitry 52 to transmit wireless power to power receiving circuitry 54 of each device 24 in system 8. Power transmitting circuitry 52 may have switching circuitry (e.g., inverter circuitry 61 formed from transistors) that is turned on and off based on control signals provided by control circuitry 16 to create AC current signals through one or more wireless power transmitting coils such as wireless power transmitting coil(s) 36. These coil drive signals cause coil(s) 36 to transmit wireless power. Multiple coils 36 may be included in device 12 (e.g., at least two coils, at least three coils, at least five coils, 3-10 coils, fewer than ten coils, fewer than eight coils, or other suitable number of coils).

As AC current from inverter 61 passes through coils 36, alternating-current electromagnetic (e.g., magnetic) fields (wireless power signals 44) are produced that are received by corresponding receiver coil(s) 48. Each wireless power receiving device 24 may have a single coil 48, at least two coils 48, at least three coils 48, at least four coils 48, or other suitable number of coils 48. Illustrative configurations in which each of devices 24 has a single wireless power receiving coil 48 may sometimes be described herein as an example.

When the alternating-current electromagnetic fields are received by coil 48 in device 24, corresponding alternating-current currents are induced in coil 48. The AC signals that are used in transmitting wireless power may have any suitable frequency (e.g., 100-250 kHz, less than 100 kHz, more than 250 kHz, etc.). Rectifier circuitry such as rectifier circuitry 50, which contains rectifying components such as synchronous rectification metal-oxide-semiconductor transistors arranged in a bridge network, converts received AC signals (received alternating-current signals associated with electromagnetic signals 44) from coil 48 into DC voltage signals for powering device 24.

The DC voltage produced by rectifier circuitry 50 (sometime referred to as rectifier output voltage Vrect) can be used in charging a battery such as battery 58 and can be used in powering other components in device 24. These components may include, for example, input-output devices 56. Input-output devices 56 may include input devices for gathering user input and/or making environmental measurements and may include output devices for providing a user with output. As an example, input-output devices 56 may include a display for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 56 may also include sensors for gathering input from a user and/or for making measurements of the surroundings of system 8. Illustrative sensors that may be included in input-output devices 56 include three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible cameras with respective infrared and/or visible digital image sensors and/or ultraviolet light cameras), gaze tracking sensors (e.g., a gaze tracking system based on an image sensor and, if desired, a light source that emits one or more beams of light that are tracked using the image sensor after reflecting from a user's eyes), touch sensors, buttons, capacitive proximity sensors, light-based (optical) proximity sensors such as infrared proximity sensors, other proximity sensors, force sensors, sensors such as contact sensors based on switches, gas sensors, pressure sensors, moisture sensors, magnetic sensors, audio sensors (microphones), ambient light sensors, optical sensors for making spectral measurements and other measurements on target objects (e.g., by emitting light and measuring reflected light), microphones for gathering voice commands and other audio input, distance sensors, motion, position, and/or orientation sensors that are configured to gather information on motion, position, and/or orientation (e.g., accelerometers, gyroscopes, compasses, and/or inertial measurement units that include all of these sensors or a subset of one or two of these sensors), sensors such as buttons that detect button press input, joysticks with sensors that detect joystick movement, keyboards, and/or other sensors. Device 12 may have one or more input-output devices 70 (e.g., input devices and/or output devices of the type described in connection with input-output devices 56). Some or all of input-output devices 70 in device 12 may also be omitted (e.g., to save space and reduce complexity for the circuitry of device 12).

Device 12 and/or device 24 may communicate wirelessly using in-band or out-of-band communications. Device 12 may, for example, have wireless transceiver circuitry 40 that wirelessly transmits out-of-band signals to device 24 using an antenna. Wireless transceiver circuitry 40 may be used to wirelessly receive out-of-band signals from device 24 using the antenna. Device 24 may have wireless transceiver circuitry 46 that transmits out-of-band signals to device 12. Receiver circuitry in wireless transceiver 46 may use an antenna to receive out-of-band signals from device 12. In-band transmissions between devices 12 and 24 may be performed using coils 36 and 48. With one illustrative configuration, frequency-shift keying (FSK) is used to convey in-band data from wireless power transmitting circuitry to wireless power receiving circuitry (e.g., from device 12 to device 24) and amplitude-shift keying (ASK) is used to convey in-band data from wireless power receiving circuitry to wireless power transmitting circuitry (e.g., from device 24 to device 12). Power may be conveyed wirelessly during these FSK and ASK transmissions.

It is desirable for power transmitting device 12 and power receiving device 24 to be able to communicate information such as received power, battery states of charge, and so forth, to control wireless power transfer. However, the above-described technology need not involve the transmission of personally identifiable information in order to function. Out of an abundance of caution, it is noted that to the extent that any implementation of this charging technology involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Control circuitry 16 may have external object measurement circuitry 41. Circuitry 41 may be used to detect whether external objects are present on the charging surface of the housing of device 12 (e.g., to detect objects on the top of a charging mat or, if desired, to detect objects adjacent to the coupling surface of a charging puck). The housing of device 12 may have polymer walls, walls of other dielectric, metal structures, fabric, and/or other housing wall structures that enclose coils 36 and other circuitry of device 12. The charging surface may be a planer outer surface of the upper housing wall of device 12 or an outer surface having other shapes (e.g., concave, convex, etc.). Circuitry 41 can detect foreign objects such as coils, paper clips, and other metallic objects and can detect the presence of wireless power receiving devices 24 (e.g., circuitry 41 can detect the presence of one or more coils 48).

During object detection and characterization operations, external object measurement circuitry 41 can be used to make measurements on coils 36 and/or on other coils such as optional foreign object detection coils in device 12 to determine whether any devices 24 are present on device 12. In an illustrative arrangement, measurement circuitry 41 of control circuitry 16 contains signal generator circuitry such as a pulse generator that supplies control signals to inverter 61. These control signals cause inverter 61 to create impulses so that impulse responses can be measured by circuitry 41 (e.g., by using a voltage sensor, an analog-to-digital converter configured to convert analog voltage measurements to digital voltage measurements, and/or other sensing circuitry). Measurement circuitry 41 may also have alternating-current sources and other circuitry for making measurements on coil 36. In some embodiments, quality-factor measurements are made on coil 36 to determine whether a foreign object is present.

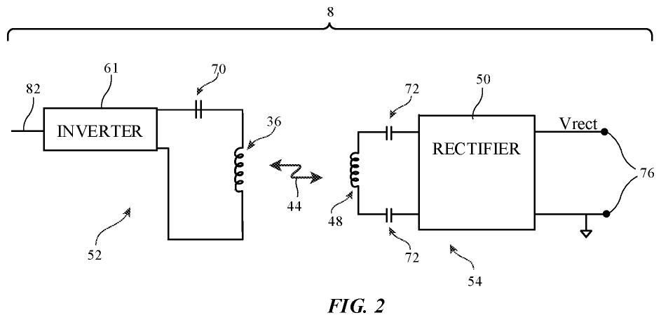

FIG. 2 shows illustrative wireless power circuitry in system 8. The wireless power circuitry of FIG. 2 includes wireless power transmitting circuitry 52 and wireless power receiving circuitry 54. During operation, wireless power signals 44 are transmitted by wireless power transmitting circuitry 52 and are received by wireless power receiving circuitry 54. As shown in FIG. 2, wireless power transmitting circuitry 52 includes inverter circuitry 61. Inverter circuitry (inverter) 61 may be used to provide signals to coil 36.

During wireless power transmission, the control circuitry of device 12 supplies signals to control input 82 of inverter circuitry 61 that cause inverter 61 to supply alternating-current drive signals to coil 36. Circuit components such as capacitor 70 may be coupled in series with coil 36 as shown in FIG. 2. When alternating-current current signals are supplied to coil 36, corresponding alternating-current electromagnetic signals (wireless power signals 44) are transmitted to nearby coils such as illustrative coil 48 in wireless power receiving circuitry 54. This induces a corresponding alternating-current (AC) current signal in coil 48. One or more capacitors such as capacitors 72 may be coupled in series with coil 48. Rectifier 50 receives the AC current from coil 48 and produces corresponding direct-current power (e.g., direct-current voltage Vrect) at output terminals 76. This power may be used to power a load.

In an illustrative embodiment, wireless power transmitting circuitry 52 is located in device 12 and wireless power receiving circuitry such as circuitry 54 of FIG. 2 is located in each of devices 24. This allows device 12 to transmit power wirelessly to devices 24 to charge their batteries. Arrangements in which device 12 includes wireless power receiving circuitry such as circuitry 54 may also be used (e.g., so that device 12 can receive power wirelessly from a wireless charging mat and/or so that device 12 can receive wireless power from one or more of devices 24). In arrangements in which device 12 contains wireless power receiving circuitry 54 for receiving wireless power from one or more of devices 24, each of those one or more devices 24 may have corresponding wireless power transmitting circuitry 52 to transmit wireless power to circuitry 54.

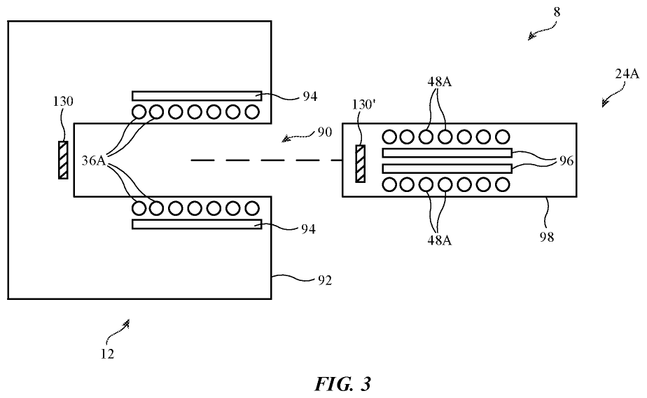

FIG. 3 is a diagram showing how system 8 may have mating wireless power devices. In the example of FIG. 3, system 8 includes wireless power receiving device 24A. Device 24A may be a wireless earbud that receives wireless power from wireless power transmitting device 12 to charge a battery in device 24A.

Device 24A has circuitry of the type described in connection with device 24 of FIG. 1 (e.g., wireless communications circuitry, wireless power receiving circuitry, control circuitry, input-output devices, etc.). Device 24A has a housing such as housing 98 that is configured to be worn in or on a user's ear. This allows a speaker in device 24A to provide sound to the user's ear. To receive wireless power, device 24A has wireless power receiving coil 48A (e.g., a coil such as coil 48 of FIG. 1). The turns of coil 48A form a solenoid that surrounds a layer of magnetic material such as ferrite layer 96, which helps control the propagation of magnetic fields in device 24A. The housing of device 24A has an elongated stalk portion on which coil 48A is mounted. Device 12 has a corresponding mating elongated recess such as recess 90 in housing 92 (sometimes referred to as a device housing, electronic device housing, electronic item housing, or item housing). Device 12 may have ferrite layer 84. Ferrite layer 84 surrounds a wireless power transmitting coil such as coil 36A (e.g., a solenoid that serves as coil 36 of FIG. 1). When it is desired to charge the battery of device 24A, the stalk portion of housing 98 is placed into recess 90. Device 12 may have a magnet such as magnet 130 that attracts an opposing magnet in device 24A such as magnet 130′, thereby helping to hold device 24A in recess 90. When the elongated portion of housing 98 is received within recess 90, wireless power transmitting device 12 can use wireless power transmitting coil 36A to transmit wireless signals that are received by corresponding wireless power receiving coil 48A of device 24A.

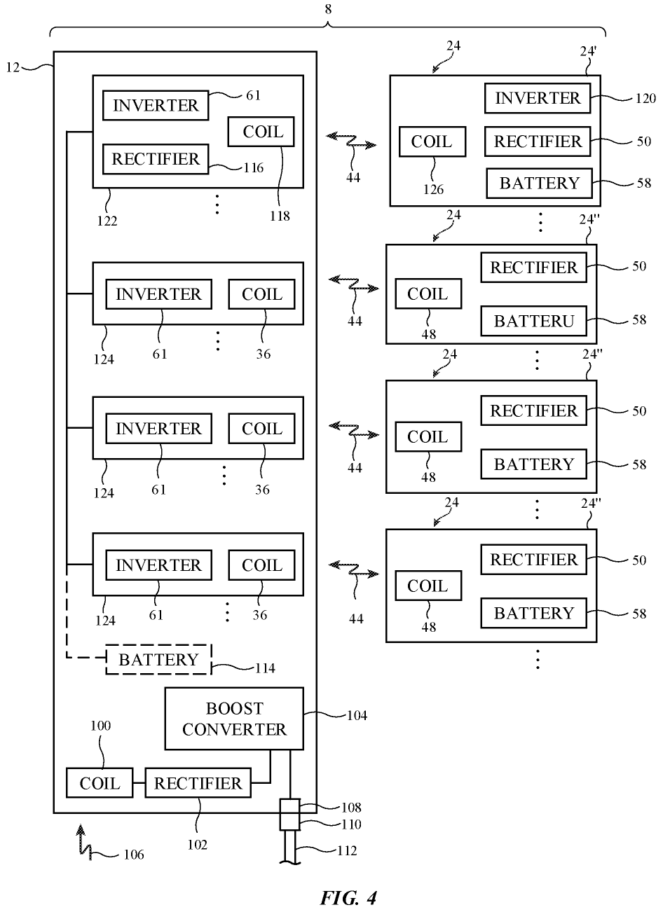

FIG. 4 is a circuit diagram of system 8 in an illustrative configuration in which device 12 has multiple wireless power coils for wirelessly transferring power with multiple associated devices 24.

Devices 24 may include devices such as device 24′ that can both transmit and receive wireless power (e.g., a cellular telephone, tablet computer, etc.) and devices 24″ that only receive wireless power (e.g., ear buds, a wrist watch, a computer stylus, etc.). Device 12 includes corresponding wireless power circuits. Wireless power circuits 124 are configured to only transmit wireless power and can be used with devices such as devices 24′ that only receive power (or, if desired, can be used with devices that can transmit and receive wireless power). Wireless power circuits such as wireless power circuit 122 can be used to both transmit and receive wireless power. Circuit 122 may be used with a wireless device that only receives wireless power, a wireless device that only transmits wireless power, or a device that both transmits and receives wireless power. Illustrative configurations in which circuit 122 is used with a device such as device 24′ that can transmit and receive wireless power are sometimes described herein as an example.

Device 12 may have circuitry for receiving wired or wireless power from an external power source. Device 12 may, as an example, have a power port such as port 108 for receiving wired power. Cable 112 may be coupled to a source of AC or DC power. Plug 110 of cable 112 may be removably coupled to port 108. When cable 112 is electrically coupled to port 108, cable 112 can be used to supply wired power to device 12.

Boost converter 104 (e.g., a switched-mode converter) can serve as a power regulator and may, as an example, receive a DC input from cable 112 or from the DC output of power converter 14 (FIG. 1). Boost converter 104 or other power regulator may have an adjustable output voltage of 5 V to 18 V (as an example). A 5 V output may be appropriate, for example, in scenarios in which only devices 24′ are present (e.g., smaller devices such as a wristwatch, ear buds, computer stylus, etc.). A larger output (e.g., of 18 V) may be appropriate when device 24′ is present (e.g., a cellular telephone or other device with a larger battery to charge).

If desired, device 12 may have wireless power receiving circuitry for receiving wireless power signals 106 from a wireless charging pad, wireless charging puck, or other external source of wireless power. For example, device 12 may include a wireless power receiving coil such as coil 100 that receives wireless power signals 106. Device 12 may use rectifier circuitry 102 to convert AC signals induced in coil 100 by wireless power signals 106 into rectified DC voltage. The DC voltage may be regulated by boost converter 104. Wirelessly received power and/or wired power from cable 112 may be used in charging optional internal battery 114 and otherwise powering the circuitry of device 12.

As shown in FIG. 4, circuit 122 has a wireless power coil such as coil 118 that can serve both as a wireless power transmitting coil and as a wireless power receiving coil. Device 24′ (which is sometimes referred to as a wireless power receiving device but which can also transmit wireless power) has a corresponding wireless power coil such as coil 126. Device 24′ of FIG. 4 may be, for example, a cellular telephone, tablet computer, laptop computer, etc.). Coil 126 of device 24′ may serve as a wireless power transmitting coil and as a wireless power receiving coil.

When it is desired to transmit wireless power from device 12 to device 24′, inverter 61 of circuit 122 drives AC signals onto coil 118 of circuit 122 that produce wireless power signals 44. These wireless power signals are received by coil 126 and converted into DC power for charging battery 58 in device 24′ by rectifier 50 in device 24′. In some scenarios, it may be desired to transmit wireless power from device 24′ to device 12. For example, device 12 may not include battery 114 or battery 114 may be depleted. Device 12 may also not be within range of a device supplying wireless power signals 106 and may not be coupled to cable 112. In this type of situation, power from battery 58 of device 24′ can be harvested by device 12 and redistributed to one or more of devices 24″. As an example, some of the battery power from a cellular telephone (device 24′) may be redistributed to a computer stylus and earbuds (devices 24″). This allows a user to resupply accessories with power by sacrificing a relatively small fraction of the power available in device 24′ when the user is not able to plug device 12 into a wired power source.

When it is desired to transmit wireless power from device 24′ to device 12, inverter 120 (e.g., inverter circuitry such as the circuitry of inverter 61 of FIG. 2) drives AC signals through coil 126 to produce wireless signals 44 that are received by coil 118 and rectifier 116 of device 12. Rectifier 116 (e.g., rectifier circuitry such as rectifier 50 of FIG. 2) rectifies the AC signals induced in coil 118 by signals 44 from device 24′ and produces a DC voltage for device 12. Boost converter 104 may regulate this DC voltage, if desired.

In a device that contains both a rectifier and an inverters (e.g., a device such as device 12 or a device such as device 24′ in the example of FIG. 4), the rectifier and inverter can be implemented using separate circuits (e.g., separate sets of diodes, transistors, and/or control circuits, etc.). In some configurations, it may be desirable to conserve hardware resources. In these types of configurations, a shared circuit can serve as both an inverter and a rectifier. For example, the control circuitry of a device can be configured to control a common inverter/rectifier circuit in that device such as a full bridge circuit formed from transistors such as metal-oxide-semiconductor field-effect transistors. In a first mode of operation (sometimes referred to as “inverter mode”), the control circuitry applies control signals to the full bridge circuit that cause the full bridge to serve as an inverter and thereby produce AC drive signals. In a second mode of operation (sometimes referred to as “rectifier mode”), the control circuitry applies control signals to the full bridge circuit that cause the full bridge circuit to serve as a rectifier and thereby rectify received AC signals to form corresponding DC signals. The inverter and rectifier circuits of devices 12 and 24 may, in general, be implemented using shared inverter/rectifier bridge circuits (or other shared circuitry) that is dynamically configured to operate either as an inverter or rectifier by control circuitry 16 during operation and/or may be implemented using separate inverter and rectifier circuits. The schematic diagram of FIG. 4 represents both of these illustrative possibilities.

Devices 24″ may include one or more computer styluses (sometimes referred to smart pencils or smart pencils with wireless charging), one or more wristwatches, one or more ear buds, and/or other smaller devices and/or accessories. If desired, devices 24″ may include one or more battery cases. As an example, devices 24″ may include an ear bud battery case that includes a) a battery, b) recesses for receiving ear buds, c) circuitry for charging the ear buds from the battery using wired and/or wireless power techniques, and d) wireless power receiving circuitry and/or wired power receiving circuitry for charging the battery. Each of devices 24″ may include a wireless power receiving coil 48, a rectifier 50 for rectifying AC signals induced in the coil by received wireless power signals 44, and a battery 58 that may be charged with the output of the rectifier.

Wireless power receiving devices 24″ may mate with corresponding wireless power transmitting circuits 124 of device 12. Each of circuits 124 may include an inverter 61 for supplying AC drive signals to a corresponding wireless power transmitting coil 36. During wireless power transfer operations, coils 36 supply wireless power signals to coils 48 of devices 24″. One or more types of device 24″ may receive power from each coil 36. For example, a given coil 36 may be used in transmitting wireless power to a first device during operation in a first mode and may be used in transmitting wireless power to a second device (e.g., a device of a different type than the first device) during operation in a second mode. If desired, one or more of coils 36 may only be used in transmitting power to a particular type of receiving device.

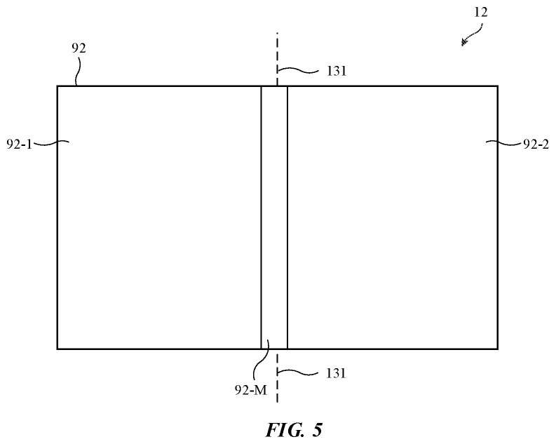

There may be any suitable number of wireless power circuits in device 12. A top view of device 12 in an illustrative configuration in which device 12 has a foldable housing is shown in FIG. 5. As shown in FIG. 5, housing 92 may include first portion 92-1 and second portion 92-2. Portions 92-1 and 92-2 may be coupled to each other (e.g., portions 92-1 and 92-2 may be joined by third portion 92-M and may fold with respect to each other along fold axis 131). One or more wireless power circuits may be formed in device 12. As an example, device 12 may have has six wireless power circuits with six corresponding wireless power coils. The wireless power coils are mounted in housing 92. Fabric layers, polymer layers, and/or layers of other material may cover the coils and other internal circuitry of device 12.

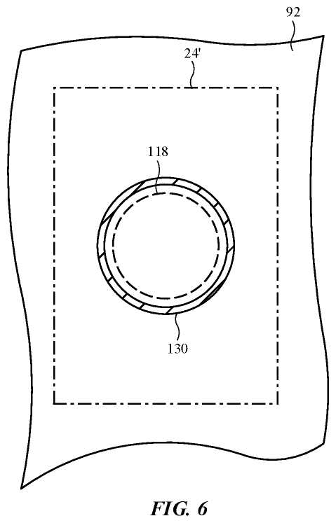

FIGS. 6, 7, 8, and 9 are top views of illustrative wireless power receiving devices 24′ and 24″ placed in alignment with corresponding wireless power coils in device 12. In general, the wireless power coils of device 12 may be located in any suitable portions of housing 92 (e.g., in portion 92-1, in portion 92-M, in and/or in portion 92-2. As shown in FIGS. 6, 7, 8, and 9, each wireless power coil in device 12 is associated with one or more corresponding magnets 130 for attracting and aligning a corresponding device 24 to that coil to support wireless power operations.

FIG. 6 is a top view of an illustrative device 24′ that has been placed on a portion of housing 92 (e.g., portion 92-1 of FIG. 5 or other portion of housing 92). In the example of FIG. 6, coil 118 of circuit 122 (FIG. 4) is associated with a corresponding magnet 130 and is configured to align with coil 126 in device 24′ (e.g., a cellular telephone or other device) when magnet 130 of device 12 attracts a corresponding magnet in device 24′.

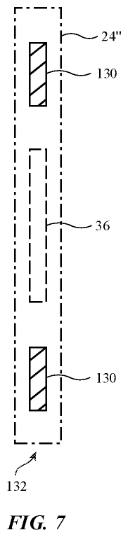

As shown in FIG. 7, one or more magnets 130 may be placed adjacent to one of coils 36 in device 12 to attract one of devices 24″ (e.g., a computer stylus) to location 132 on device 12. Location 132 may be a region of housing 92 such as the area covering portion 92-M of housing 92 in FIG. 5 or other region of housing 92.

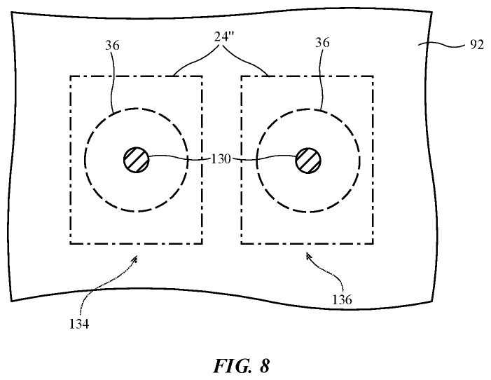

As shown in FIG. 8, one of coils 36 may have an associated magnet 130 that attracts another of devices 24″ (e.g., a wristwatch) to location 134 on housing 92 (e.g., a location on housing portion 92-2). The wristwatch may have a main body portion and a band (strap). Another of coils 36 may have an associated magnet 130 that attracts another of devices 24″ (e.g., an ear buds battery case) to location 136 on housing 92 (e.g., a location on housing portion 92-2).

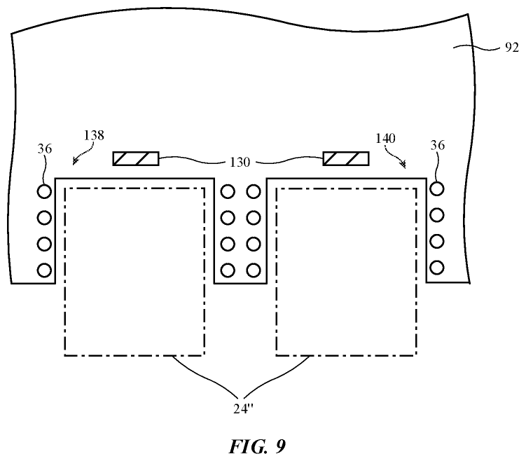

As shown in FIG. 9, another of coils 36 may have an associated magnet 130 that attracts another of devices 24″ (e.g., a first ear bud) to location 138 and another of coils 36 may have an associated magnet 130 that attracts another of devices 24″ to location 140. Locations 138 and 140 may, as an example, be located along one of the edges of housing 92 (e.g., coils 36 at locations 138 and 140 may be at upper and/or lower edges of housing portion 92-2, at left and/or right edges of housing 92 such as the right edge of housing portion 92-2, etc.). Devices 24″ of FIG. 9 may have elongated ear bud stalk portions in their housings that are received within corresponding elongated recesses in device 12 as described in connection with recess of FIG. 3 (e.g., so that ear bud stalk portions protrude from the right edge, lower edge, upper edge, and/or left edge of housing 92).

Housing 92 may be insufficiently large to store all of devices 24′ and 24″ when closed or may be sufficiently large to store one, some, or all of devices 24′ and 24″ when closed (e.g., housing 92 may optionally serve as an enclosure that receives one, some, or all of devices 24′ and 24″ when housing portions 92-1 and 92-2 are folded together). Configurations in which device 12 is insufficiently large to store any of devices 24′ and/or 24″ (or in which device 12 can only store a computer stylus in location 132 and ear buds in locations 138 and 140 when closed) may be relatively compact. In some embodiments, the interior of device 12 may, if desired, have sufficient room to store cable 112 and/or other items (e.g., credit cards, identification cards, etc.).

In a configuration in which housing portions 92-1 and 92-2 have been unfolded with respect to each other about fold axis 131, device 24′ of FIG. 6 (e.g., a cellular telephone) may rest on portion 92-1, device 24″ of FIG. 7 (e.g., a computer stylus) may be placed on a first coil 36 in device 12 along axis 131, and additional devices 24″ of FIGS. 8 and 9 may be placed in alignment with additional coils 36 in portion 92-2. These additional devices 24″ may include a wristwatch, an earbuds case, a pair of earbuds, and/or other devices. If desired, device 12 may be operated in a folded configuration (e.g., a configuration in which housing 92 has been folded along axis 131). In some embodiments, device 12 may be folded along a fold axis defined by a pair of nearby parallel housing bends on opposing sides of a computer stylus.

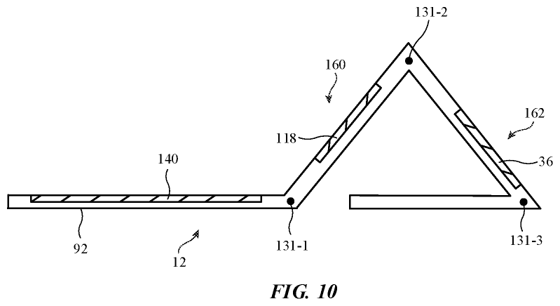

In the illustrative arrangement of FIG. 10, device 12 serves as a cover for an electronic device (e.g., device 24′). For example, device 12 may be a removable tablet computer case for a tablet computer. Housing 92 of device 12 in FIG. 10 has multiple bendable regions and folds along three fold axes: fold axis 131-1, fold axis 131-2, and fold axis 131-3. An optional keyboard such as keyboard 140 and other input-output devices (e.g., a trackpad, etc.) may be formed in housing 92. Device 12 may use coil 118 to transmit and/or receive wireless power from device 24′ (e.g. while device 24′ is being supported in an upright viewing position for a user at location 160). Device 12 may use one or more additional coils such as coil 36 to supply wireless power to other devices 24″ (e.g., a computer stylus, a wristwatch, ear buds, an ear buds case, or other device at location 162).

In general, device 12 (which may sometimes be referred to as a wireless power transmitting item, an electronic device, an electronic item, a portable item, etc.) may have a housing such as housing 92 that is formed from polymer, glass, metal, fabric, other materials, and/or combinations of these materials. One or more electronic devices may receive wireless power from device 12. In some configurations, an electronic device (e.g., a cellular telephone, etc.) may be coupled to device 12 by a wired connection and may supply power to device 12 over the wired connection and/or may wirelessly transmit power to device 12. Housing 92 may be foldable, may have no folds, may have sliding portions, may form a removable case, may have a rigid structure (e.g., so that device 12 may snap onto the exterior of another device), may have soft and rigid portions, may have portions that form straps, may form a stand or other support structure, may have wearable support structures that allow device 12 to be worn on an arm or head or other user body part, and/or may have other suitable configurations. The embodiments of device 12 described in connection with FIGS. 5 and 6 are illustrative.

The foregoing is merely illustrative and various modifications can be made to the described embodiments. The foregoing embodiments may be implemented individually or in any combination.

What is claimed is:

1. A wireless power transmitter, comprising:
a foldable housing enclosing a plurality of wireless power coils configured to operate respectively with a plurality of wireless power receiving devices;
a first wireless power circuit including a first wireless power coil of the plurality of wireless power coils, wherein the first wireless power circuit can transmit and receive wireless power; and
a second wireless power circuit including a second wireless power coil of the plurality of wireless power coils, wherein the second wireless power circuit can transmit wireless power;
wherein the first wireless power circuit and the second wireless power circuit are operable in:
a first mode in which the first wireless power circuit uses the first wireless power coil to transmit wireless power to a first external electronic device with wireless power receiving circuitry, and
a second mode in which the first wireless power circuit uses the first wireless power coil to receive wireless power from the first external electronic device and to generate corresponding power and the second wireless power circuit uses the generated power to drive the second wireless power coil to transmit wireless power signals to a second external electronic device separate from the external electronic device, thereby harvesting power from the first external electronic device and redistributing the harvested power to the second external electronic device.

2. The wireless power transmitter of claim 1 wherein the second wireless power circuit is not capable of receiving wireless power.

3. The wireless power transmitter of claim 1 further comprising:
one or more magnets that cooperate with one or more corresponding magnets in the second electronic device to align a wireless power coil in the second external electronic device with the second wireless power coil.

4. The wireless power transmitter of claim 1 further comprising a third wireless power circuit including a third wireless power coil of the plurality of wireless power coils, wherein:
the third wireless power circuit can transmit wireless power; and
the third wireless power circuit is operable in the second mode to use the generated power to drive the third wireless power coil to transmit wireless power signals to a third external electronic device different from the first and second external electronic devices, thereby harvesting power from the first external electronic device and redistributing the harvested power to the third external electronic device.

5. The wireless power transmitter of claim 4 further comprising:
one or more first magnets that cooperate with one or more corresponding magnets in the first external electronic device to align a wireless power coil in the first external electronic device with the first wireless power coil;
one or more second magnets that cooperate with corresponding magnets in the second external electronic device to align a wireless power coil in the second external electronic device with the second wireless power coil;
one or more third magnets that cooperate with corresponding magnets in the third external electronic device to align a wireless power coil in the third external electronic device with the second wireless power coil.

6. The wireless power transmitter of claim 1 further comprising a converter configured to receive power from an external source, wherein the first and second wireless power circuit transmit the received power from the external source to the first and second external electronic devices when operating in the first mode.

7. The wireless power transmitter of claim 6 wherein the external source is a wired power source and the converter has an adjustable output voltage selectable based on the first or second external electronic devices.

8. The wireless power transmitter of claim 6 wherein the external source is a wireless power source and the converter is fed by a wireless power receiving coil of the plurality of wireless power coils via a rectifier.

9. The wireless power transmitter of claim 1 further comprising:
one or more first magnets that cooperate with corresponding magnets in the first external electronic device to align a wireless power coil in the first external electronic device with the first wireless power coil; and
one or more second magnets that cooperate with corresponding magnets in the second external electronic device to align a wireless power coil in the second external electronic device with the second wireless power coil.

10. A wireless power transmitter, comprising:
a housing having at least adjacent first and second housing portions that fold along a first fold axis;
wireless power transmitting circuitry disposed within the housing, the wireless power transmitting circuitry including a plurality of wireless power transfer coils including a first wireless power transfer coil disposed in the first housing portion and a second wireless power transfer coil disposed in the second housing portion;
one or more first magnets having or disposed in a ring circular shape that is concentric with the first coil and that cooperates with one or more corresponding magnets in a first external electronic device to align a wireless power transfer coil of the first external electronic device with the first wireless power transfer coil; and
one or more second magnets that cooperate with one or more corresponding magnets in a second external electronic device to align a wireless power transfer coil of the second external electronic device with the second wireless power transfer.

11. The wireless power transmitter of claim 10 wherein the one or more second magnets have an elongated shape extending along and covering the fold axis and the second external electronic device is a computer stylus.

12. The wireless power transmitter of claim 10 wherein the one or more second magnets are surrounded by the third coil and the second external electronic device is a smartwatch.

13. The wireless power transmitter of claim 10 further comprising:
a third housing portion adjacent the second housing portion so that the second and third housing portions fold along a third fold axis, wherein the wireless power transmitting circuitry disposed within the housing further includes a third wireless power transfer coil disposed within the third housing portion; and
one or more third magnets that cooperate with one or more corresponding magnets in a third external electronic device to align a wireless power transfer coil of the third external electronic device with the third wireless power transfer coil.

14. The wireless power transmitter of claim 13 wherein the second external electronic device and the third external electronic device are different types of electronic device and the one or more second magnets have a different configuration than the one or more third magnets.

15. The wireless power transmitter of claim 10 wherein:
in a first mode of operation, the wireless power transmitting circuitry transmits wireless power to the first electronic device using the first wireless power transfer coil in a first mode of operation; and
in a second mode of operation, the wireless power transmitter circuitry receives wireless power from the first external electronic device and uses the received wireless power to transmit wireless power to the second external electronic device, thereby harvesting power from the first external electronic device and redistributing the harvested power to the second external electronic device.

16. The wireless power transmitter of claim 15 wherein the first external electronic device comprises a cellular telephone.

17. A wireless power transmitter, comprising:
a housing comprising at least first and second portions that fold relative to each other along a first fold axis;
a port in the housing that receives a removable cable carrying wired power;
a first wireless power coil disposed in the first portion of the housing;
a first inverter coupled to the first wireless power coil that transmits wireless power to a first electronic device using the first wireless power coil;
a second wireless power coil disposed in the second portion of the housing; and
a second inverter coupled to the second wireless power coil that transmits wireless power to a second electronic device using the second wireless power coil.

18. The wireless power transmitter of claim 17 further comprising:
a third wireless power coil disposed in a third portion of the housing, wherein the third portion of the housing folds relative to the first or second portions along a second fold axis; and
a third inverter coupled to the third wireless power coil that transmits wireless power to a third electronic device using the third wireless power coil.

19. The wireless power transmitter of claim 17 wherein:
the first electronic device is a cellular telephone; and
the second electronic device is a wristwatch.

20. The wireless power transmitter of claim 17 further comprising a rectifier coupled to the first wireless power coil that receives wireless power from the first electronic device via the first wireless power coil.

21. The wireless power transmitter of claim 20 wherein the rectifier and the first inverter are a common rectifier/inverter circuit.

22. The wireless power transmitter of claim 20 wherein:
the first electronic device is a cellular telephone;
the second electronic device is a wristwatch;
in a first mode, the first inverter transmits wireless power derived from an external source to the cellular telephone and the second inverter transmits wireless power derived from the external source to the wristwatch; and
in a second mode, the rectifier receives wireless power from the cellular telephone, and the second inverter transmits wireless power derived from the received wireless power to the wristwatch, thereby harvesting power from the cellular telephone and redistributing the harvested power to the wristwatch.

23. The wireless power transmitter of claim 20 wherein:
the first electronic device is a cellular telephone;
the second electronic device is a wireless earphone case;
in a first mode, the first inverter transmits wireless power derived from an external source to the cellular telephone and the second inverter transmits wireless power derived from the external source to the wireless earphone case; and
in a second mode, the rectifier receives wireless power from the cellular telephone, and the second inverter transmits wireless power derived from the received wireless power to the wireless earphone case, thereby harvesting power from the cellular telephone and redistributing the harvested power to the wireless earphone case.
